(19) United States
(12) Patent Application Publication
(10) Pub. No.: US 2017/0161961 A1
(43) Pub. Date: Jun. 8, 2017

(54) PARKING SPACE CONTROL METHOD AND SYSTEM WITH UNMANNED PAIRED AERIAL VEHICLE (UAV)

(71) Applicant: Paul Salsberg, Toronto (CA)

(72) Inventor: Paul Salsberg, Toronto (CA)

(21) Appl. No.: 15/361,469

(22) Filed: Nov. 27, 2016

Related U.S. Application Data
(60) Provisional application No. 62/263,792, filed on Dec. 7, 2015.

(51) Int. Cl. G07B 15/00; H04N 7/18; G06K 9/00; G06K 9/62; G07B 1/08; B64C 39/02

(52) U.S. Cl. CPC G07B 15/00; G07B 1/08; B64C 39/024; G06K 9/00651; G06K 9/00771; G06K 9/6215; H04N 7/183; B64C 2201/127

(57) ABSTRACT

A method for parking space control including the steps of: a) flying a drone at regular intervals along a predefined path that covers an area of a parking lot; b) scanning and registering the parking lot; c) using, by software, features detection techniques as a part of image analysis algorithms; d) scanning and searching data from the parking lot for similarities within a given time period to form an analysis; e) determining, by the analysis, two outcomes for a specific parking lot including either a new vehicle is parked or an old vehicle is still located at the same parking lot; f) registering new vehicles at the time of detection; g) registering and checking longer parked vehicles' stay time for violation; h) determining if there is a violation; i) flagging and marking the vehicle(s) on a smart phone or tablet for an officer to view, locate, and ticket, if the answer to step h is yes; j) determining if the parking time exceeds the one allowed in the area of the parking lot; k) flagging ticket alerts on the program and emailing to the supervisor for evaluation and printing, if answer to step j is yes; l) determining if a vehicle can be exempt from the rules; m) deciding, by the supervisor, to generate a ticket with a click of a button, if answer to step 1 is no; n) creating, by the supervisor, the ticket; o) walking to the vehicle in order to assign the ticket thereto; and p) repeating cycle after an hour or as approved.

### CROSS REFERENCE TO RELATED APPLICATIONS

The instant non-provisional patent application claims priority from provisional patent application No. 62/263,792, filed on Dec. 7, 2015, entitled PARKING SPACE CONTROL METHOD AND SYSTEM WITH PAIRED UAV, and incorporated herein in its entirety by reference thereto.

### BACKGROUND OF THE INVENTION

Field of the Invention

The embodiments of the present invention relate to a parking space control method and a system, and more particularly, the embodiments of the present invention relate to a parking space control method and system with unmanned paired aerial vehicle (UAV).

In still more particularly, the embodiments of the present invention relate to a complete parking space control system and a method that is capable of automatically managing and controlling a whole process from the time a vehicle enters a parking lot to the time it departs, including detecting a vehicle in the parking area using video data, determining parking time and violation detection by using a program for a very high speed image recognition technique.

In yet more particularly, the embodiments of the present invention relate to a method of controlling the permitted stay time of a vehicle in a non-controlled access parking area where any car can park and leave without the use of a pay terminal and a boom gate.

Description of the Prior Art

Numerous innovations for drones have been provided in the prior art. Even though these innovations may be suitable for the specific individual purposes to which they address, nevertheless, they differ from the embodiments of the present invention.

### SUMMARY OF THE INVENTION

Thus, an object of the embodiments of the present invention is to provide a parking space control method and a system with a paired UAV specification, which avoids the disadvantages of the prior art.

Briefly stated, another object of the embodiments of the present invention is to provide a method for parking space control including the steps of: a) flying a drone at regular intervals along a predefined path that covers an area of a parking lot; b) scanning and registering the parking lot; c) using, by software, features detection techniques as a part of image analysis algorithms; d) scanning and searching data from the parking lot for similarities within a given time period to form an analysis; e) determining, by the analysis, two outcomes for a specific parking lot, including either a new vehicle is parked or an old vehicle is still located at the same parking lot; f) registering new vehicles at the time of detection; g) registering and checking longer parked vehicles' stay time for violation; h) determining if there is a violation; i) flagging and marking the vehicle(s) on a smart phone or tablet for an officer to view, locate, and ticket, if the answer to step h is yes; j) determining if the parking time exceeds the one allowed in the area of the parking lot; k) flagging ticket alerts on the program and emailing to the supervisor for evaluation and printing, if answer to step j is yes; l) determining if a vehicle can be exempt from the rules; m) deciding, by the supervisor, to generate a ticket with a click of a button, if answer to step 1 is no; n) creating, by the supervisor, the ticket; o) walking to the vehicle in order to assign the ticket thereto; and p) repeating cycle after an hour or as approved.

Provided are a parking space control method and system. In particularly, a thorough parking control system and a method that are capable of automatically managing and controlling a whole process from a time a vehicle enters a parking lot to a time it leaves, including detecting a vehicle in the parking area, using the image data, determining parking time, and violation detection by using a server incorporating therein a program for a very high speed image recognition technique.

For this purpose, included is a UAV containing an on-board (4k) digital camera that follows a predefined path and covers the area of the parking lot at regular intervals at a specific altitude to get a birds-eye view of the lot. The software algorithm analyzes the image and the video data is sent by the UAV camera.

There is a potential for the development of a new methodology using a computer program and systems that record the parking time of a vehicle at a parking lot with minimized direct human intervention. The objective of the embodiments of the present invention is to fulfill this potential.

The embodiments of the present invention provide a method for identifying the parking time of a vehicle at a given parking lot and ultimately pinpoints an over-time violation. The violation is based on a sign posting the maximum parking time in the parking lot. To achieve this, a drone follows a predefined path that is designed to cover the surveillance of the entire area of the parking space. The UAV conducts flights at regular intervals preprogrammed by the (parking) officer operating the program.

The software algorithms of the system of the embodiments of the present invention analyze the images sent by the UAV camera during flights. The algorithms determine the features of each new image and differences that specifically apply to parking lots in the image. Vehicles are identified based on edge detection techniques. The UAV follows exactly the same path and flies at exactly the same altitude in order to capture images that have exactly the same perspective. Human figures walking near the cars or entering the cars are extrapolated from the analysis in order to prevent erroneous detection.

Occasionally, and if visibility and safety allows it, the supervisor is authorized to take manual control of the drone and navigate it to a location that allows the scan of a plate of a vehicle. The same action can be automated and preprogrammed when the drone can operate safely while maneuvering on a less predictable and possibly safe path. At these periods, image analysis will be terminated. Image analysis will resume once the drone returns to its regular path.

More than one path of operation of the drone can be preprogrammed via the application, the purpose being the ability to meet different weather conditions or to operate only at the open sections of a specific parking space. Each drone will have a training mode that allows supervisors to “teach” the drone the path they believe would cover all of the spaces that need to be supervised during the drone working hours, and feed in a clean map—with no vehicles—that represent the lot area. It is recommended that the lot be constructed with the required white lines so that the software is able to accurately define the position and size of each vehicle.

The novel features considered characteristic of the embodiments of the present invention are set forth in the appended claims. The embodiments of the present invention themselves, however, both as to their construction and to their method of operation together with additional objects and advantages thereof will be best understood from the following description of the embodiments of the present invention when read and understood in connection with the accompanying figures of the drawing.

### BRIEF DESCRIPTION OF THE FIGURES OF THE DRAWING

The figures of the drawing are briefly described as follows:

FIGS. 1A-1G are a flowchart of the method of the embodiments of the present invention controlling a parking lot;

FIG. 2 is a block diagram of the main algorithm workflow for the method of the embodiments of the present invention controlling the parking lot;

FIGS. 3A-3G are a flowchart of the main algorithm workflow for the method of the embodiments of the present invention controlling the parking lot;

FIG. 4 is a block diagram of the system of the embodiments of the present invention controlling the parking lot;

FIG. 5 is a screen shot of the home page of the application of the method of the embodiments of the present invention;

FIG. 6 is a screen shot for switching between five modes of the application of the method of the embodiments of the present invention;

FIG. 7 is a screen shot for flight path creation of the application of the method of the embodiments of the present invention;

FIG. 8 is a screen shot for completing a configuration flight of the application of the method of the embodiments of the present invention;

FIG. 9 is a screen shot for adjusting the number of flights of the application of the method of the embodiments of the present invention;

FIG. 10 is a screen shot for monitoring flight of the application of the method of the embodiments of the present invention;

FIG. 11 is a screen shot for settings of the application of the method of the embodiments of the present invention; and

FIG. 12 is examples of the use of edge detection.

### LIST OF REFERENCE NUMERALS UTILIZED IN THE FIGURES OF THE DRAWING

### Method 10 for Controlling Parking Lot 12

10 method for controlling parking lot 12
12 parking lot
14 drone
15 regular intervals
16 predefined path
18 area of parking lot 12
20 software
22 features detection techniques
24 image analysis algorithms
26 data
28 similarities
30 given time period
32 analysis
34 two outcomes
36 new vehicle
38 old vehicle
40 time of detection
42 stay time
44 violation
46 smart phone
48 tablet
50 officers
52 parking time
54 ticket alerts
56 program
58 supervisor
60 personnel cars
62 other types of parked vehicles
64 vehicles of vendors of other types of parked vehicles 62
66 ticket
68 button
70 cycle

### Main Algorithm Workflow 71 for Method 10 for Controlling Parking Lot 12

71 main algorithm workflow for method 10 for controlling parking lot 12
72 three images
74 specific waypoint
76 two images
80 monitoring flight
82 image detection analysis with feature detection and key point detector and
descriptor extractor algorithm
84 selected open source library
86 BRISK
88 key points
90 areas
92 specific location
94 magnitude
96 image data defining features
98 each image
100 results
102 distances
104 key points
106 noises
108 environment
112 significant features
114 application
116 parking areas' surveillance methodologies
118 original image
120 current image
122 previous image
124 registration
126 set-up flight
128 previous flight
130 new/current image
132 current flight

### System 134 for Carrying out Method 10 for Controlling Parking Lot 12

134 system for carrying out method 10 for controlling parking lot 12
136 managing device of system 134
138 image capture device of system 134
140 storage device of system 134
142 user device of system 134
144 network of system 134
146 controller of managing device 136 of system 134 is for controlling analysis of video data 148 received by UAV camera 150
148 video data
150 UAV camera
152 processor of controller 146
154 memory
156 vehicle capture module of managing device 136
158 user device
160 video buffering module of memory 154
162 image buffering module
164 vehicle matching module of memory 154
166 stationary vehicle detection module 166 of memory 154
168 timing module of memory 154
170 violation detection module of memory 154
172 UAV programming module
174 bus
176 at least one communication interface
178 image source

### DETAILED DESCRIPTION OF THE PREFERRED EMBODIMENTS

### Introductory

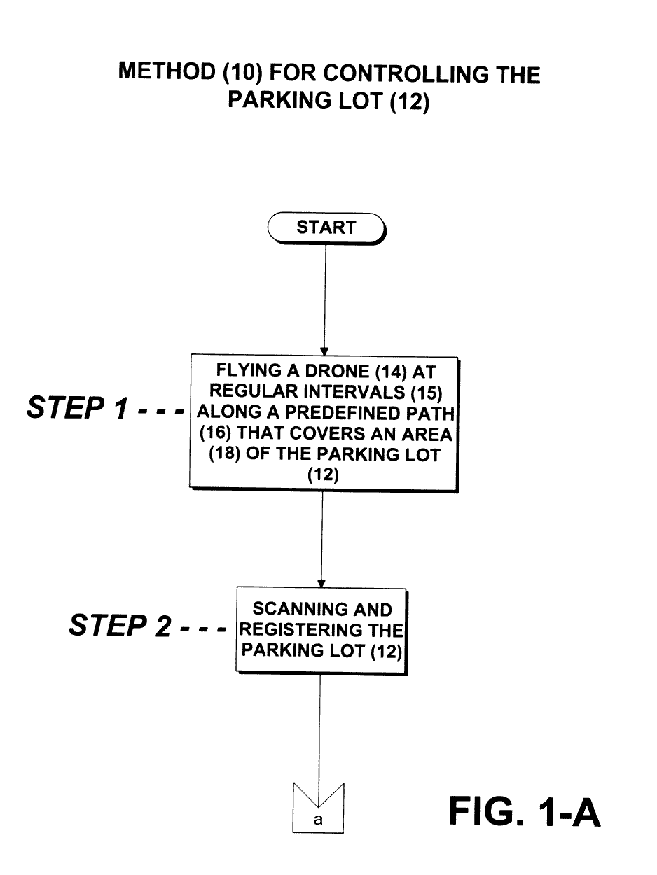

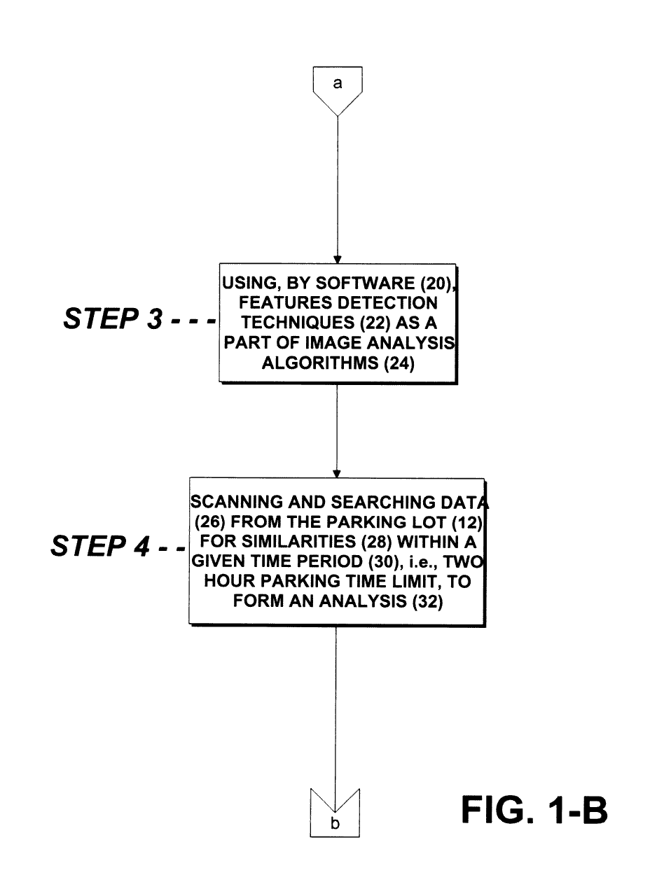

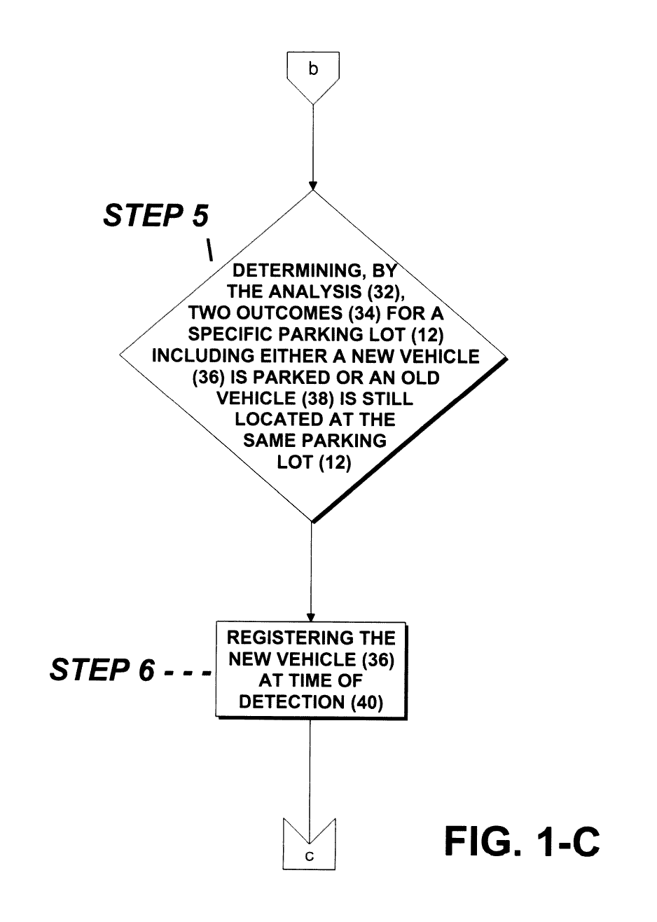

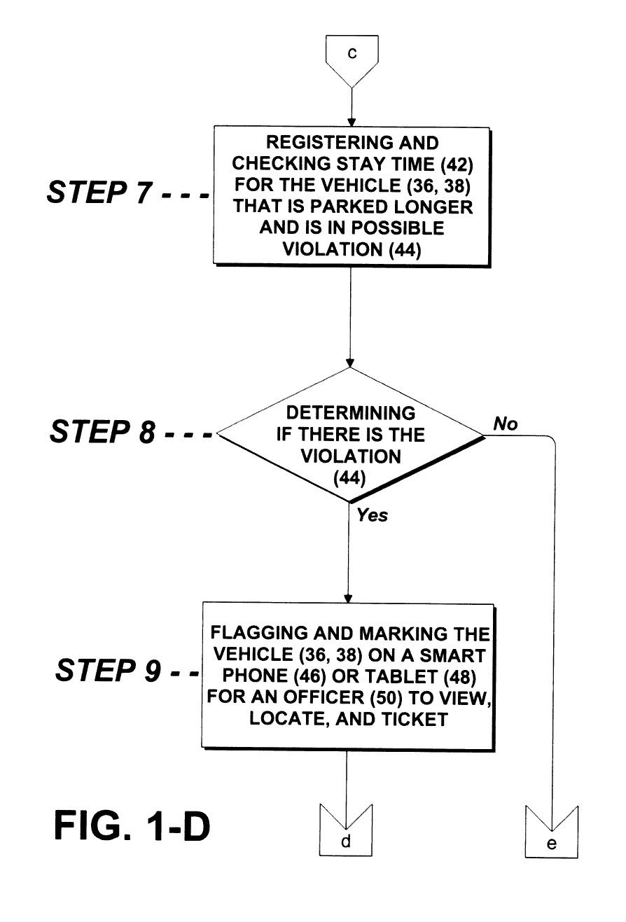

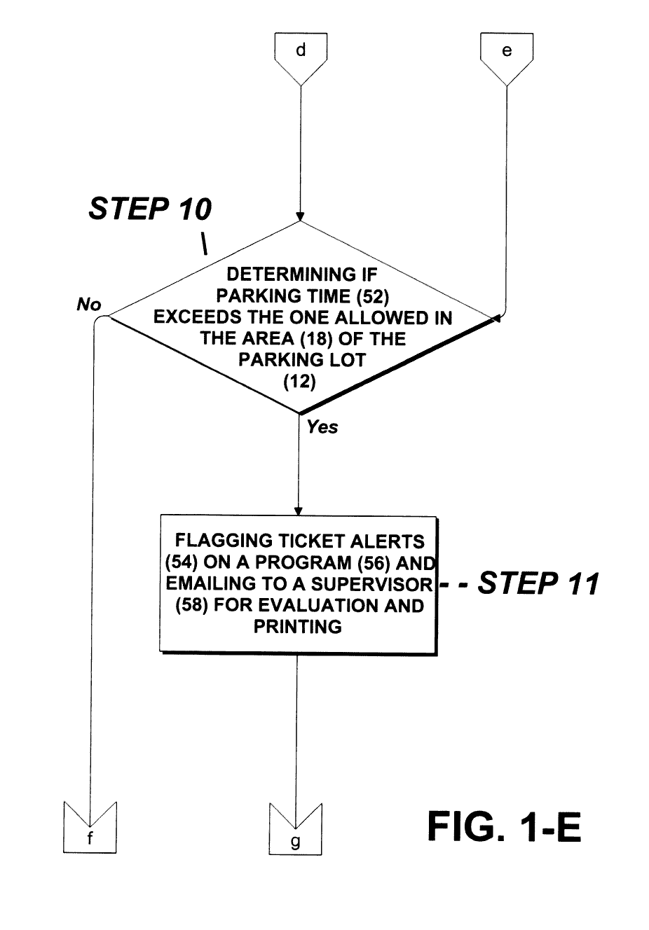

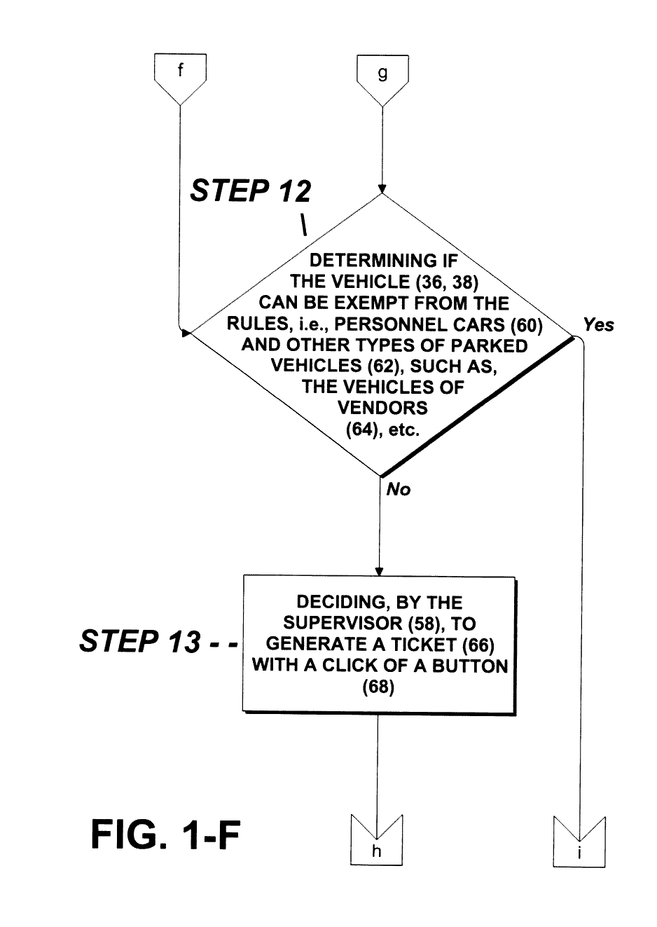

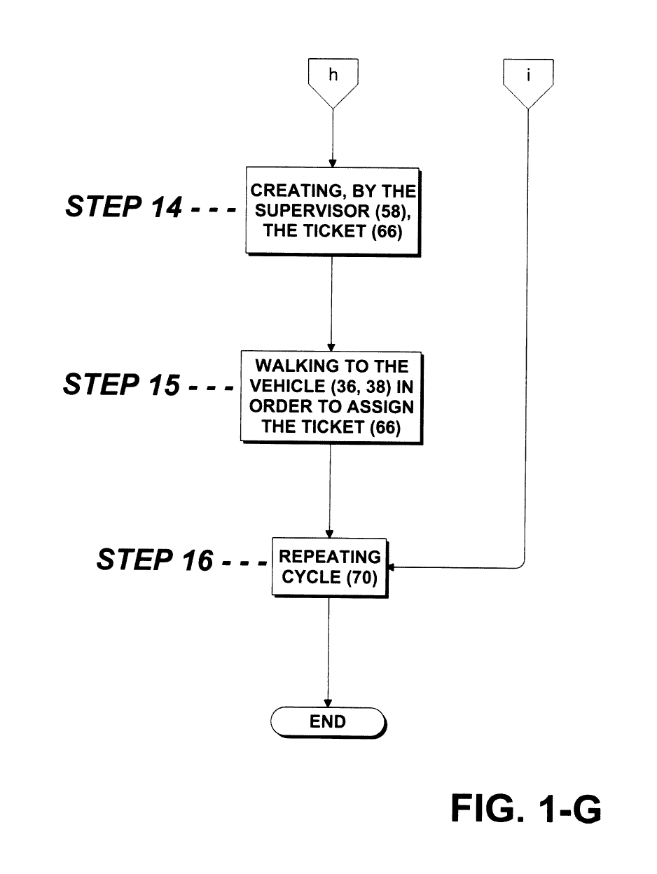

Referring now to the figures, in which like numerals indicate like parts, and particularly to FIGS. 1A-1G, the method of the embodiments of the present invention is shown at 10 for controlling a parking lot 12.

### Method 10 for Controlling the Parking Lot 12

The method 10 for controlling the parking lot 12 comprises the steps of:
STEP 1: Flying a drone 14 at regular intervals 15 along a predefined path 16 that covers an area 18 of the parking lot 12;
STEP 2: Scanning and registering the parking lot 12;
STEP 3: Using, by software 20, features detection techniques 22 as a part of image analysis algorithms 24;
STEP 4: Scanning and searching data 26 from the parking lot 12 for similarities 28 within a given time period 30, i.e., two hour parking time limit, to form an analysis 32;
STEP 5: Determining, by the analysis 32, two outcomes 34 for a specific parking lot 12 including either a new vehicle 36 is parked or an old vehicle 38 is still located at the same parking lot 12;
STEP 6: Registering the new vehicle 36 at time of detection 40;
STEP 7: Registering and checking stay time 42 for the vehicle 36, 38 that is parked longer and is in possible violation 44;
STEP 8: Determining if there is the violation 44;
STEP 9: Flagging and marking the vehicle 36, 38 on a smart phone 46 or tablet 48 for an officer 50 to view, locate, and ticket, if the answer to STEP 8 is yes;
STEP 10: Determining if parking time 52 exceeds the one allowed in the area 18 of the parking lot 12;
STEP 11: Flagging ticket alerts 54 on a program 56 and emailing to a supervisor 58 for evaluation and printing, if answer to STEP 10 is yes;
STEP 12: Determining if the vehicle 36, 38 can be exempt from the rules, i.e., personnel cars 60 and other types of parked vehicles 62, such as, the vehicles of vendors 64, etc.;
STEP 13: Deciding, by the supervisor 58, to generate a ticket 66 with a click of a button 68, if answer to STEP 12 is no;
STEP 14: Creating, by the supervisor 58, the ticket 66;
STEP 15: Walking to the vehicle 36, 38 in order to assign the ticket 66 thereto;
STEP 16: Repeating cycle 70 after an hour or as approved.

### Main Algorithm Workflow 71 for the Method 10 for Controlling the Parking Lot 12

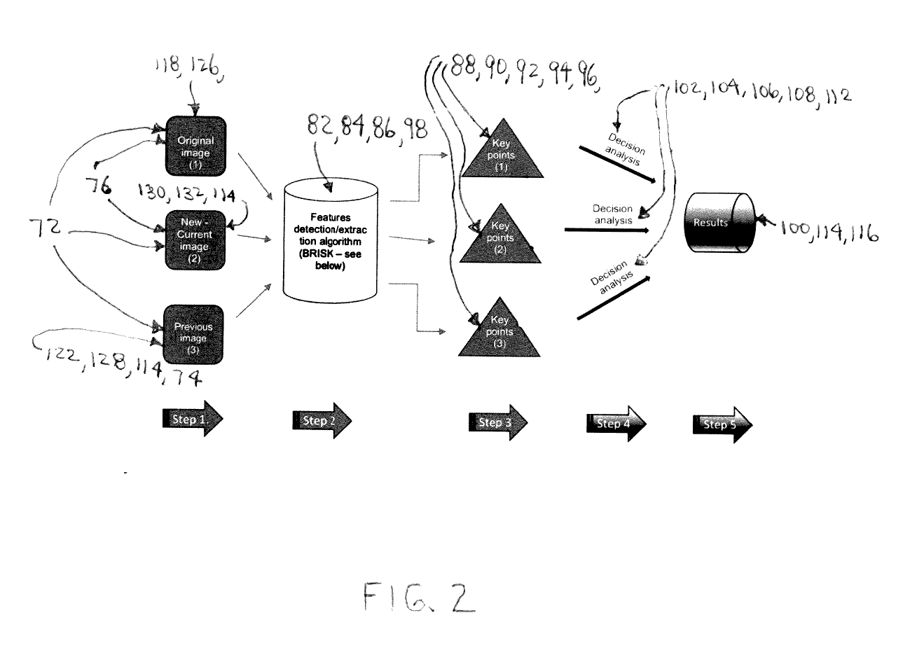

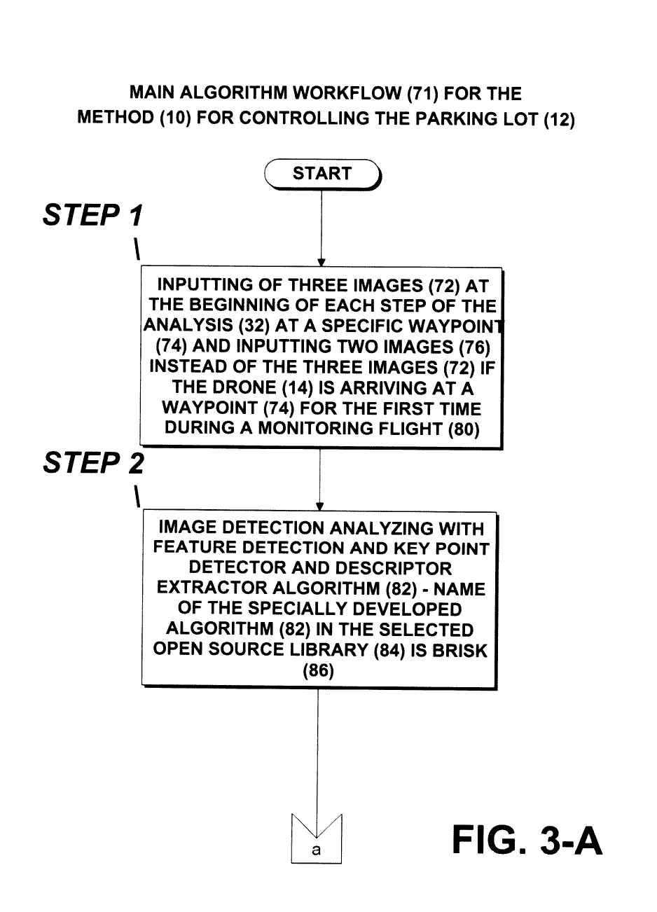

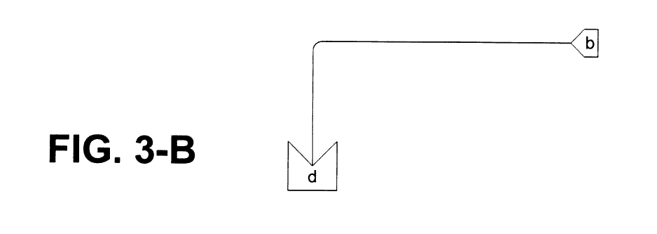

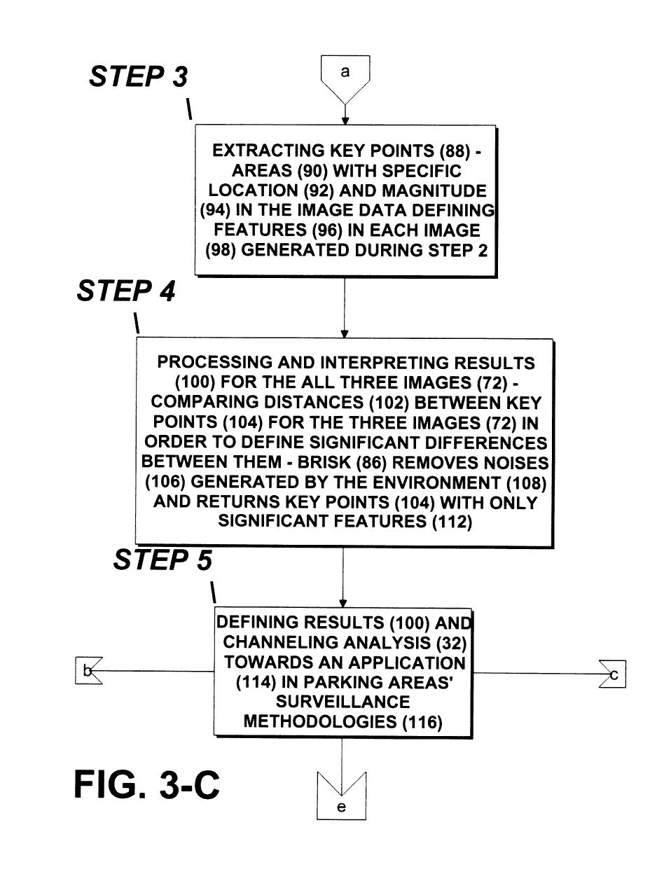

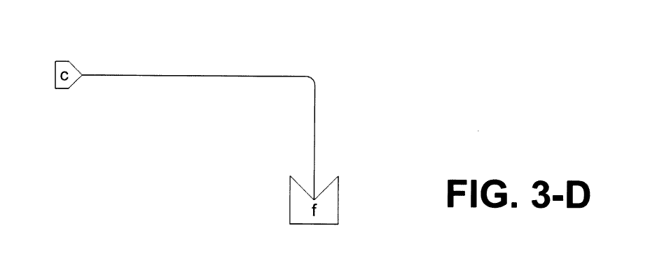

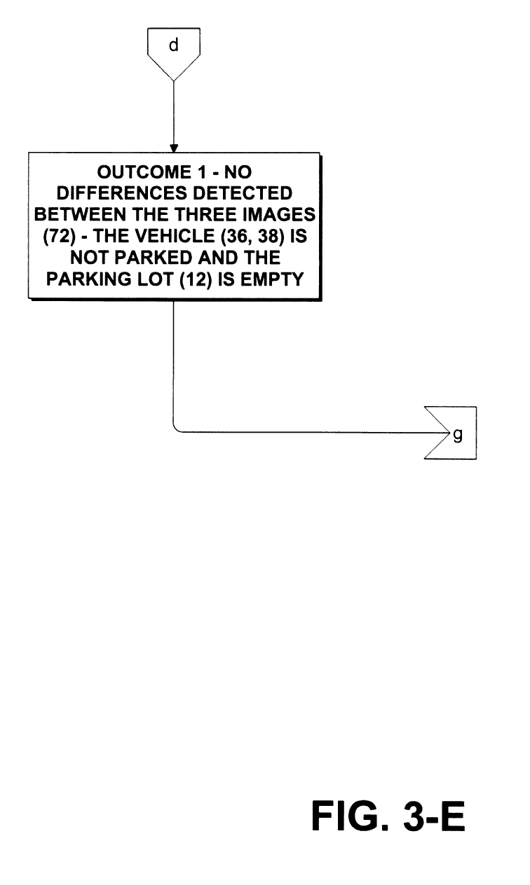

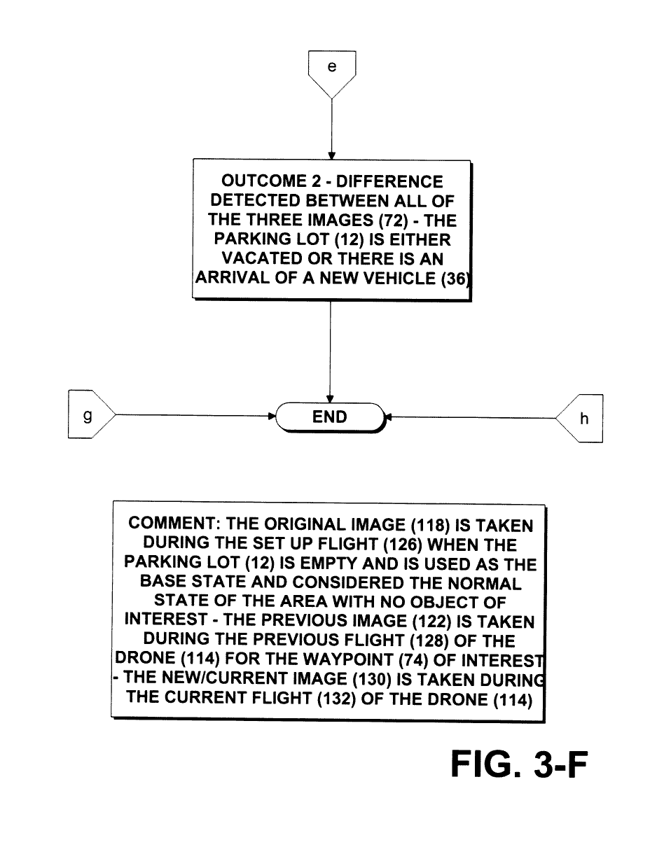

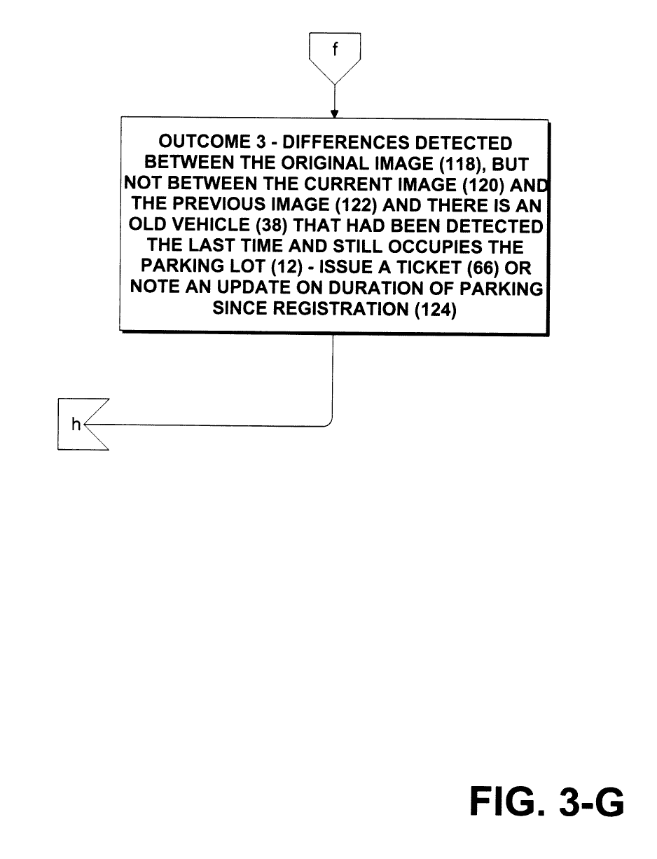

The main algorithm workflow 71 for the method 10 for controlling the parking lot 12 can best be seen in FIGS. 2 and 3A-3G, and as such, will be discussed with reference thereto.
STEP 1: Input of data—Input of three images 72 at the beginning of each step of the analysis 32 at a specific waypoint 74. Input two images 76 instead of the three images 72 if the drone 14 is arriving at a waypoint 74 for the first time during a monitoring flight 80;
STEP 2: Image detection analysis with feature detection and key point detector and descriptor extractor algorithm 82. Name of the specially developed algorithm 82 in the selected open source library 84 is BRISK 86. http://docs.opencv.org/trunk/de/dbf/classcv_1_1BRISK.html. More on applications and applicability at http://cs229.stanford.edu/proj2012/Schaeffer—Comparison Of Keypoint Descriptors In The Context Of Pedestrian Detection.pdf;
STEP 3: Extracting Key points 88—Areas 90 with specific location 92 and magnitude 94 in the image data defining features 96 in each image 98 generated during STEP 2;
STEP 4: Decision Analysis—Processing and interpreting results 100 for the all three images 72—Comparing distances 102 between key points 104 for the three images 72 in order to define significant differences between them. BRISK 86 removes noises 106 generated by the environment 108 and returns key points 104 with only significant features 112; and
STEP 5: Defining results 100 and channeling analysis 32 towards an application 114 in parking areas' surveillance methodologies 116:
   Outcome 1—No differences detected between the three images 72. Vehicle 36, 38 is not parked and the parking lot 12 is empty;
   Outcome 2—Difference detected between all of the three images 72. The parking lot 12 is either vacated or there is an arrival of a new vehicle 36; and
   Outcome 3—Differences detected between the original image 118 but not between the current image 120 and the previous image 122. There is an old vehicle 38 that had been detected the last time and still occupies the parking lot 12. Issue a ticket 66 or note an update on duration of parking since registration 124.

It is to be understood that the original image 118 is taken during the set-up flight 126 when the parking lot 12 is empty and persisted and used as the base state—considered the normal state of the area with no object of interest.

It is to be further understood that the previous image 122 is taken during the previous flight 128 of the drone 114 for the waypoint 74 of interest.

It is to be still further understood that the new/current image 130 is taken during the current flight 132 of the drone 114 for the waypoint 74 of interest. For the key point 104 please see STEP 2, supra, and for the decision analysis 32 please see STEP 4, supra.

The embodiments of the present invention teach an image-based parking control system that automates the monitoring of parking spaces and detects any violations of parked vehicles.

The system includes a managing device that is adapted to receive an image and/or video of a vehicle transmitted from a camera that is installed on an unmanned aerospace vehicle (UAV). The UAV flies at regular intervals along a predefined path that covers the area of a parking lot. The software uses image data provided by UAV in order to analyze a territory with certain number of parking lots. The software uses features detection techniques as a part of image analysis algorithms in order to determine the presence of new vehicles, and eventually detect parked vehicles that exceed the allowed time by the parking lot manager/owner.

The parking lot is scanned and registered. The software program applies the image analysis technique developed for the detection of differences in the images' data. The UAV follows exactly the same path and flies at exactly the same altitude in order to capture images that have exactly the same perspective. Human figures walking near the cars or entering the cars are extrapolated from the analysis in order to prevent erroneous detection.

Image data sent by the UAV camera is scanned and searches for similarities within a given time period, i.e., two hour parking time limit. The analysis determines two outcomes for a specific lot, either a new vehicle is parked or an old vehicle is still located at the same lot. Longer vehicles' stay is registered and checked for violation. The vehicle(s) are flagged and marked on a tablet for the officer to view and find the vehicles that might need to be ticketed if a violation is determined.

If the parking time exceeds the one allowed in the area, a ticket alert is sent to the supervisor for evaluation and print. Occasionally, a vehicle can be exempt from the rules, i.e., personnel cars and other types of parking involving vendors, etc. The system checks for exception, if the vehicle is exempt the ticket is closed. If a vehicle is not exempted, the supervisor can decide to generate a ticket. After locating the vehicle, the supervisor creates the ticket, and walks to the vehicle in order to assign the ticket.

An option is provided to display the exact path to each vehicle with currently registered violation. Statistics with the vehicle status, duration of violation, and past history, is displayed on the application screen. The parking controller has the option to preview the path to each vehicle with violation. The system provides instructions for reaching out to a vehicle using the shortest path based on the supervisors' current location.

A voice service providing vocal instructions for the currently selected route is implemented as well. The voice service can be turned on/off at any point by the supervisor, and has only auxiliary function. Written instructions will always be displayed on the screen. A ‘smart routes’ option will display the sequence of routes that suggests a path that goes over all parking lots with violations for the shortest time. The route will be computed by the program and will be dynamically updated based on the presence of new violations or other factors affecting the position of the officer. Here, the cycle will be end and will automatically repeat after an hour or as the supervisor directs it.

### System 134 for Carrying out the Method 10 for Controlling the Parking Lot 12

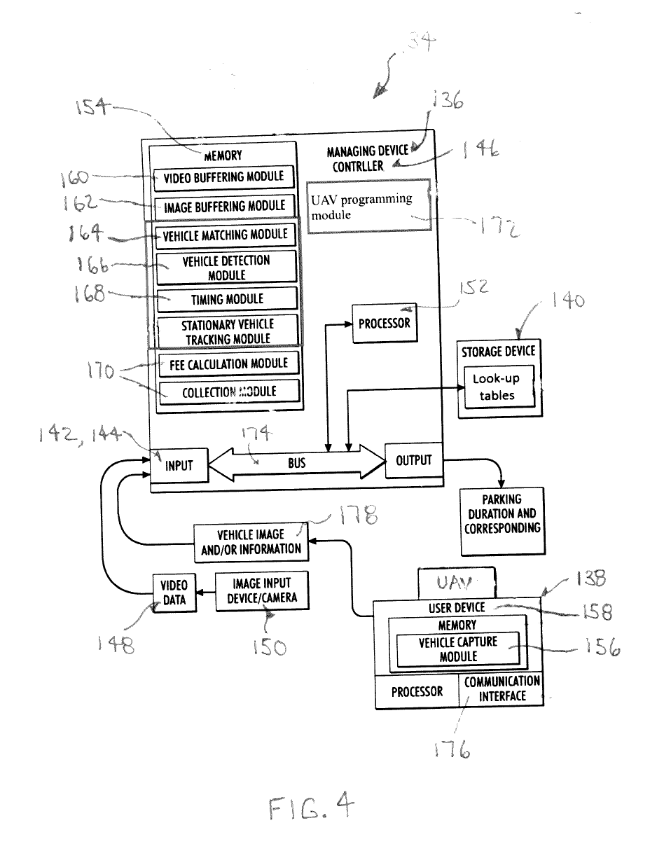

Referring now to FIG. 4, the system 134 includes a managing device 136, an image capture device 138, a storage device 140 and a user device 142. The user device 142 may be linked together by communication links, referred to herein as a network 144.

The managing device 136 includes a controller 146 that is part of, or associated with, the managing device 136. The exemplary controller/software 146 is adapted for controlling an analysis of video data 148 received by the UAV camera 150. The controller 146 includes a processor 152. The processor 152 controls overall operation of the managing device 136 by execution of processing instructions that are stored in memory 154 connected to the processor 152.

The memory 154 may represent any type of tangible computer readable medium, such as, random access memory (RAM), read only memory (ROM), magnetic disk or tape, optical disk, flash memory, or holographic memory.

In one embodiment, the memory 154 comprises a combination of random access memory and read only memory. The processor 152 can be variously embodied, such as, by a single-core processor, a dual-core processor (or more generally by a multiple-core processor), a digital processor and cooperating math coprocessor, a digital controller, or the like.

The managing device 136 may be embodied in a networked device, such as, a vehicle capture module 156 or user device 158, although it is also contemplated that the managing device 136 may be located elsewhere on a network to which the system 134 is connected, such as, on a central server, a networked computer, or the like, or distributed throughout the network or otherwise accessible thereto.

The processor 152, according to the instructions contained in the memory 154, performs vehicle detection, matching phases, and changes in the color, position, size, and angle of position.

In particular, the memory 154 stores a video buffering module 160 that receives video of a select parking area that is captured by a video capture device, an image buffering module 162 that receives images provided by the image capture device, a vehicle matching module 164 that matches a vehicle with a vehicle in the image data, a stationary vehicle detection module 166 that detects objects and/or vehicles within a field of view of the UAV camera 150, a timing module 168 that initiates a timer for measuring a duration that the detected vehicle remains parked in the space, a violation detection module 170 that checks if the parking time exceeds the one allowed in the area, and if so, a ticket alert is sent to the supervisor for evaluation and print. These instructions can be stored in a single module or as multiple modules embodied in the different devices.

A UAV programming module 172 encompasses any collection of, or set of, software instructions executable by the managing device 136 or other digital system so as to configure the processor 152 or the other digital system to perform a task that is an intent of the software instructions.

The term software instructions as used herein is intended to encompass such instructions stored in a storage medium, such as, RAM, a hard disk, optical disk, or so forth, and is also intended to encompass firmware that is software stored on a ROM or so forth. The software instructions may be organized in various ways, and may include software components organized as libraries, Internet-based programs stored on a remote server or so forth, source code, interpretive code, object code, directly executable code, and so forth.

It is contemplated that the software instructions may invoke a system-level code or calls to other software residing on a server (not shown) or other location to perform certain functions.

The various components of the managing device 136 are connected by a bus 174.

The managing device 136 includes at least one communication interface 176, such as, network interfaces for communicating with external devices. The at least one communication interface 176 includes at least one of a modem, a router, a cable, and an Ethernet port. The at least one communication interface 176 is adapted to receive video and/or image data as input.

The managing device 136 includes at least one special purpose or general purpose computing devices, such as, a server computer or digital front end (DFE), or any other computing device capable of executing instructions for performing the exemplary method.

The managing device 136 connected to an image source 178 for inputting and/or receiving video data and/or image data in electronic format. The image source 178 includes an image capture device, such as, the UAV camera 150, and at least one camera installed on the UAV that captures image and video data from the parking area and/or from parking area of interest. The UAV flies at regular intervals along a predefined path that covers the area.

For performing at night in parking areas without external sources of illumination, the UAV camera 150 includes near infrared (NIR) capabilities at a low-end portion of a near-infrared spectrum (700 nm-1000 nm).

### Logic and Specification of Software Algorithms

The software algorithms of the application of the embodiments of the present invention analyze the images sent by the UAV camera during its flight. The algorithms determine the features of each new image and differences that specifically apply to parking lots in the image.

Occasionally, and if visibility and safety allow it, the supervisor will take manual control of the drone and navigate it to a location that allows the scan of a plate of a vehicle.

The same action is automated and preprogrammed. At these periods, image analysis will be terminated. Image analysis will resume once the UAV returns to its regular path.

More than one path of operation of the drone can be preprogrammed via the application of the embodiments of the present invention, the purpose being the ability to meet different weather conditions or to operate only at open sections of a specific parking space. Each drone has a training mode that allows supervisors to “teach” the drone the path they believe would cover all of the spaces that need to be supervised during the drone working hours.

The algorithms use clean maps in order to identify every new object present on the lot area. Objects will first be identified in terms of bounds. The following two steps of analysis will define object identification:
STEP 1: Violation detection; and
STEP 2: Vehicle plate scan routine.

The UAV descends to a safe altitude of approximately 20-30 ft that allows the scan of the plate and exact identification of the vehicle. If an object is moving near the vehicle, the scan will be delayed until there are no objects obstructing the view of, or in proximity with, the vehicle that can cause a potential safety issue.

### Locating Vehicles with Detected Violations

The application of the embodiments of the present invention provides the option of displaying the exact path to each vehicle with a currently registered violation. Statistics with the vehicle status, duration of violation, and past history, are displayed on the application screen. The parking controller has the option to preview the path to each vehicle with a violation.

The application of the embodiments of the present invention provides instructions for reaching out to a vehicle using the shortest path based on the supervisor's current location. A voice service providing vocal instructions for a currently selected route will be implemented as well. The voice service can be turned on/off at any point by the officer, and has only auxiliary function.

Written instructions will always be displayed on the screen. A “smart routes” option displays the sequence of routes that suggests a route that goes over all lots with violations for the shortest time. The route will be computed by the program and is dynamically updated based on the presence of a new violation or other factors affecting the position of the officer.

### Application Specifications

On the main screen, the user has the option to switch between video live view, latest captured image, waypoints (report for each waypoint), and full path (map), modes.

In the camera mode (Live View), the UAV camera is displayed.

In the reports mode, a table view is displayed with currently occupied lots and their status, wherein tapping on a specific cell leads to a detailed view displaying the details of the lot, i.e., when it was lastly occupied, for how long, and if the time spent by the vehicle is more than the allowed time for this lot, wherein the reports' table contains information regarding special lots as well, i.e., lots that might be reserved by the personal and need not be tracked or at least at that day are exempt from ticketing for any reason, and wherein a detailed view might provide the option to print a ticket.

In the Full Path Mode, the full path and all waypoints of the route, the UAV position (a red icon on the map), and the user location are displayed.

In the Latest Mode, the most recent image captured by the UAV is displayed, along with overlays for the individual parking lots showing their statuses.

### Settings

The camera settings can be adjusted, i.e., quality, recording time, and frequency.

To change the settings of the UAV, a static setting for each program is available so as not to possibly interfere with the accuracy of analysis.

The ability to monitor the current UAV statistics and state, i.e., battery level, flight height, speed, and other more sophisticated options that should not be displayed on the main view of the application of the embodiments of the present invention.

### History

The user has the ability to view, e-mail, and print all created tickets. Tickets can be archived. A usability chart displaying an increase or decrease in the number of violations can be generated for further reference and management reporting.

In some implementations, the processes and logic flows described in the application of the embodiments of the present invention can be performed by one or more programmable processors executing one or more computer programs to perform functions by operating on input data and generating output thereby tying the process to a particular machine, e.g., a machine programmed to perform the processes described herein.

The processes and logic flows can also be performed by, and apparatus can also be implemented as, special purpose logic circuitry, e.g., an FPGA (field programmable gate array) or an ASIC (application specific integrated circuit).

Some embodiments of the present invention may be implemented, for example, using a machine or tangible computer-readable medium or article that may store an instruction or a set of instructions that, if executed by a machine, may cause the machine to perform a method and/or operations in accordance with the embodiments. This machine may include, for example, any suitable processing platform, computing platform, computing device, processing device, computing system, processing system, computer, processor, or the like, and may be implemented using any suitable combination of hardware and/or software.

The machine-readable medium or article may include, for example, any suitable type of memory unit, memory device, memory article, memory medium, storage device, storage article, storage medium, and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

To the extent not included supra, a computer readable media suitable for storing computer program instructions and data also includes all forms of nonvolatile memory, media and memory devices, including, by way of example, semiconductor memory devices, e.g., EPROM, EEPROM, and flash memory devices, magnetic disks, e.g., internal hard disks or removable disks, magneto optical disks; and CD ROM and DVD ROM disks. The processor and the memory can be supplemented by, or incorporated in, special purpose logic circuitry.

The instructions may include any suitable type of code, such as, source code, compiled code, interpreted code, executable code, static code, dynamic code, encrypted code, and the like, implemented using any suitable high-level, low-level, object-oriented, visual, compiled, and/or interpreted programming language. To the extent not included above, the instructions also can include, for example, interpreted instructions, such as, script instructions, e.g., JavaScript or ECMA Script instructions, or executable code, Standard interchange language (SIL), Component Object Model (COM) enabled programming languages, or other instructions stored in a computer readable medium including existing and future developed instructions specific to portable electronic devices, mobile applications, and servers.

Unless specifically stated otherwise, it may be appreciated that terms, such as, “processing,” “computing,” “calculating,” “determining,” or the like, refer to the action and/or processes of a computer or computing system, or similar electronic computing device that manipulates and/or transforms data represented as physical quantities, e.g., electronic, within the computing system's registers and/ or memories into other data similarly represented as physical quantities within the computing system's memories, registers, or other similar information storage, transmission, or display devices.

To provide for interaction with a user, implementations of the subject matter described in the application of the embodiments of the present invention can be operable to interface with a computing device that is integrated with, or connected on, (directly or indirectly) a display, e.g., a CRT (cathode ray tube) or LCD (liquid crystal display) monitor for displaying information to the user.

To provide for input by a user to the computer, implementations of the application of the embodiments of the present invention further can be operable to interface with a keyboard, a pointing device, e.g., a mouse or a trackball, scanner, a barcode reader, a magnetic strip reader, or any other input device.

### Specifications and Algorithms

### Home View

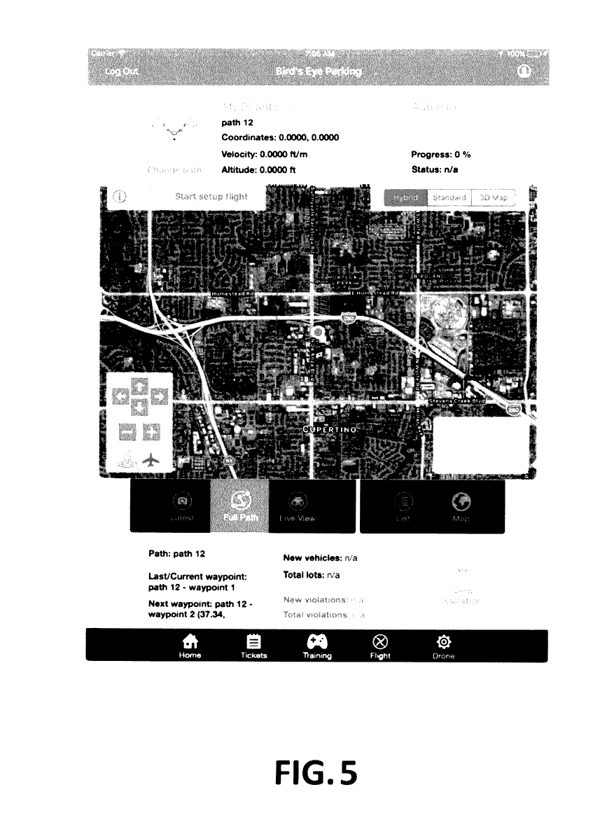

Referring now to FIG. 5, the main home view, i.e., the first screen after launch is shown.

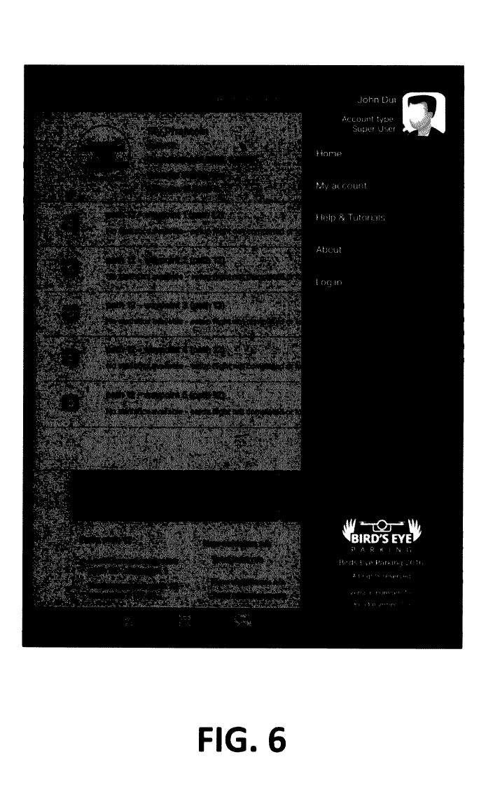

As shown in FIG. 6, in home view, the user can switch between five modes, including latest, full path, live view, list, and map.

### Latest

In this mode, the main screen view displays the image from the latest waypoint that is visited by the UAV.

### Full Path

In this mode, the full current path, the user location, and UAV location are displayed on the map.

### Live View

In this mode, a streaming camera input from the UAV is displayed.

### List

In this mode, all waypoints in the current path are displayed, including statistics, such as, coordinates, number of tickets issues at each waypoint, etc.

### Map

In this mode, a map view of the area is displayed. The user can switch between Hybrid, Standard, and 3DMap.

User info and account section is accessible via the top right icon in the Home view.

### Flight Path Creation—Summary of Configuration Steps

New flight paths are created from the ‘Training’ section of the application of the embodiments of the present invention.

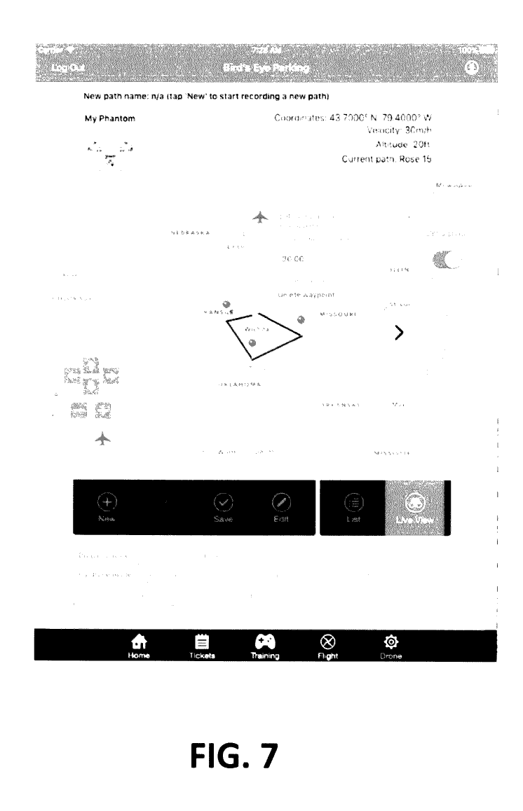

The user can create as many paths as needed for any number of areas, edit, delete, and assign the same as the UAV current preprogrammed path at any point in time. As shown in FIG. 7, a single path is created by dropping pins on a map in the Training section, specifying a unique pathname.

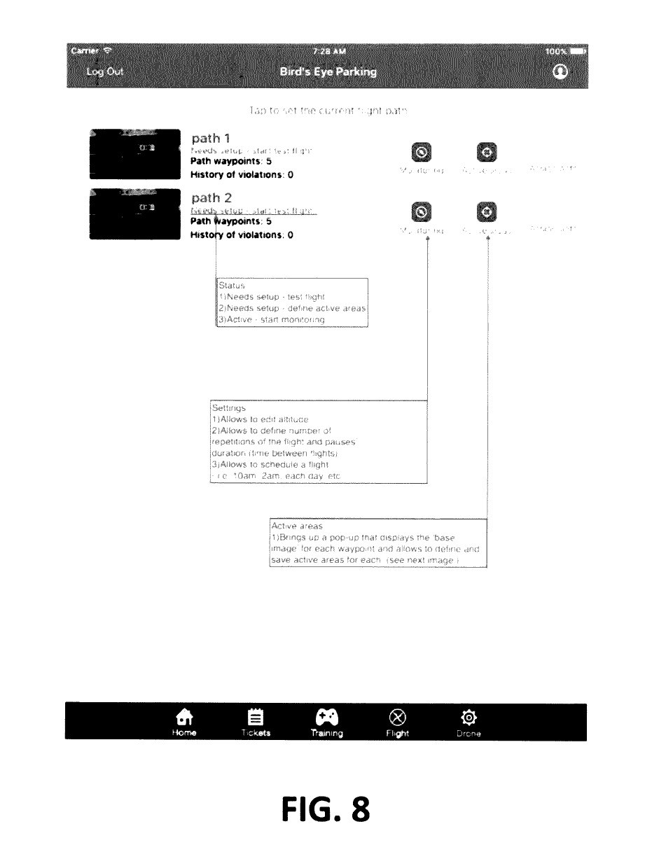

As shown in FIG. 8, the user needs to complete a configuration flight to gather images at each waypoint. The images should contain the “base state” of the area, i.e., the parking space should be empty. In this state, there will be no objects that should be considered for analysis, i.e., any parked vehicles on these images will be ignored during the monitoring flights of the drone and not tracked. The Test setup flight is a mandatory step.

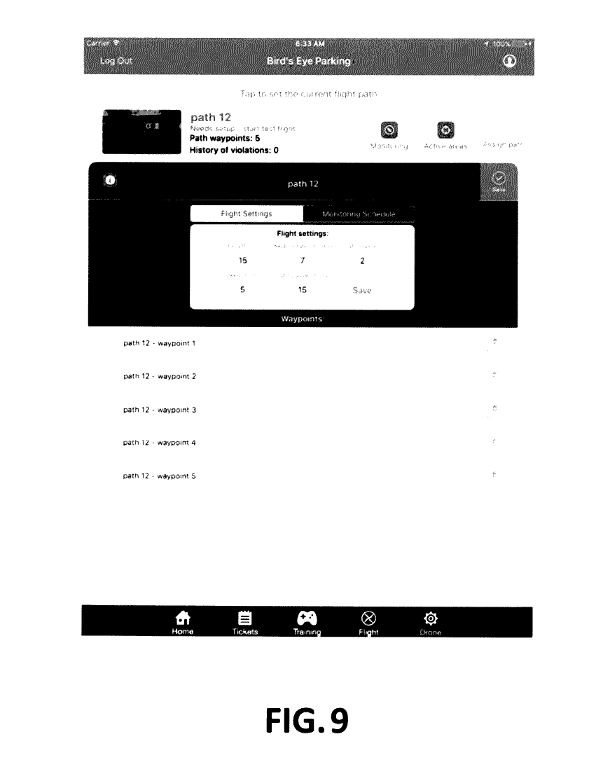

As shown in FIG. 9, the user can alter the flight settings at a later time using the “Monitoring”' button next to each saved path in the Flight section of the application of the embodiments of the present invention, i.e., image with an open path configuration panel below.

The user can adjust the number of flight and pause time between each flight, create a schedule to execute an autonomous flight at a specific day and time, and/or alter the altitude, and pause at waypoint settings for the selected flight.

Waypoints can be deleted from the current path, however, this process is not reversible and a warning is issued to the user before they confirm the deletions of a specific waypoint.

### Monitoring Flight

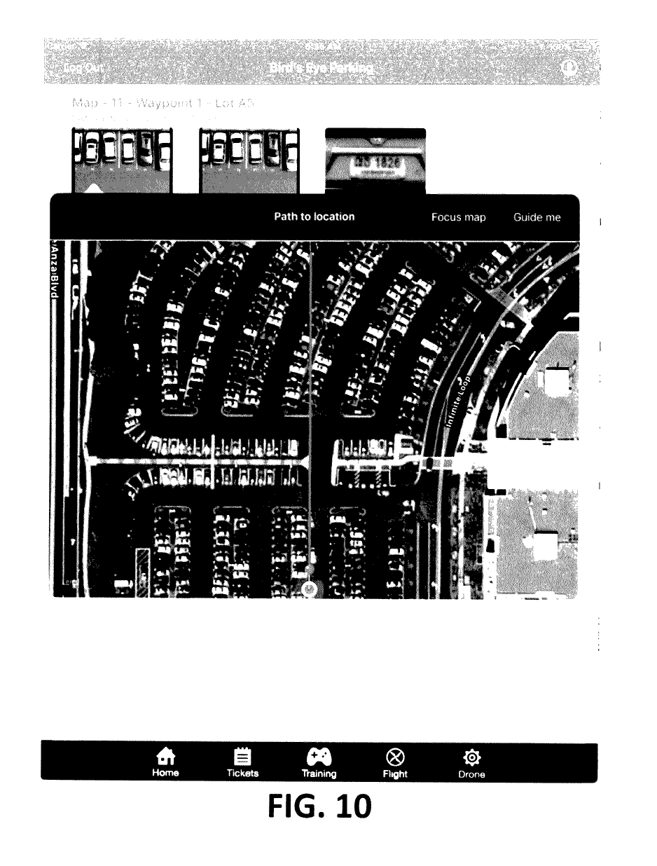

As shown in FIG. 10, once the user creates a flight path and completes its setup, the application of the embodiments of the present invention will display its status as “Active” in the “Training” section.

Areas with no violations will are highlighted in blue and areas with violations are highlighted in red.

If a violation is detected, the UAV drone automatically pauses the current flight and descends to a safe height near the detected vehicle in order to scan its plate.

A ticket will be automatically generated by the application of the embodiments of the present invention or a 3d party software. The information regarding the ticket includes all evidence gathered by the UAV, such as, digital images, are sent to a dedicated server along with a corresponding brief report signed by the operating officer supervising the UAV and the application.

There is a “lead me” functionality that guides the user to the location of the vehicle or lot of interest using a map and voice directions. The officer has the option to print and leave a ticket at the vehicle location.

The UAV is capable of operating autonomously during the incident of a ticket, and manual take over and disruption of its path should be allowed only if the officer explicitly requests a need to terminate autonomous flight and enters a security pin in order to authorize the termination.

All tickets are displayed in the History section of the application of the embodiments of the present invention. The officer has the ability to view a digital copy of the generated ticket, or open a map describing the path to the vehicle location.

### Settings

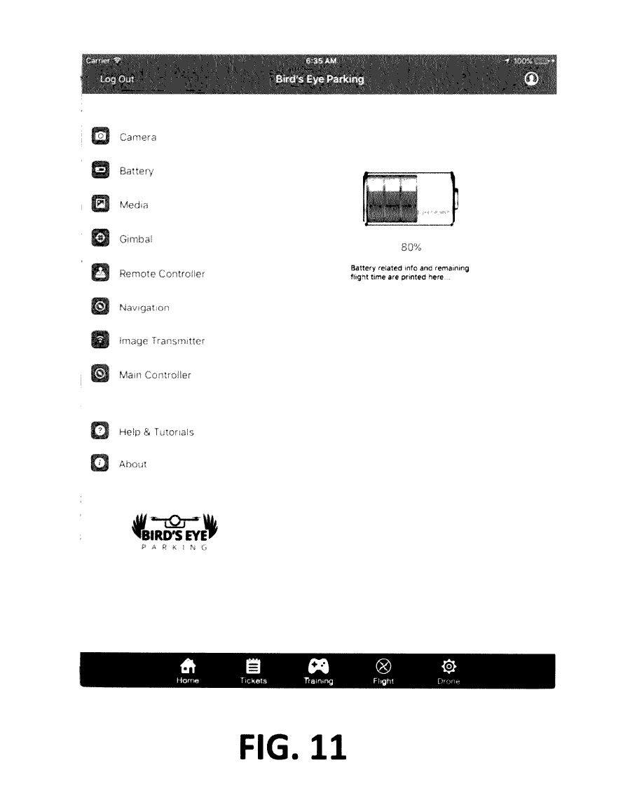

As shown in FIG. 11, the Drone section allows the user to configure very precisely the UAV. Modifying a setting requires the officer to enter his/her security pin in order to save the new setting value and write the same to the UAV firmware, unless the option is excluded under the specific officer account .

### Algorithms—Image Analysis

The application of the embodiments of the present invention uses sophisticated algorithms in order to conduct analysis of the images downloaded from the UAV during its monitoring flight. Specifically, the algorithms of choice use the Edge detecting technique, which is a well known technique for image analysis and features detection and extrapolation.

Edge detection includes a variety of mathematical methods that aim at identifying points in a digital image at which the image brightness changes sharply or, more formally, has discontinuities. The points at which image brightness changes sharply are typically organized into a set of curved line segments termed edges. The same problem of finding discontinuities in 1D signals is known as step detection and the problem of finding signal discontinuities over time is known as change detection. Edge detection is a fundamental tool in image processing, machine vision, and computer vision, particularly, in the areas of feature detection and feature extraction.

Source: https://en.wikipedia.org/wiki/Edge_detection

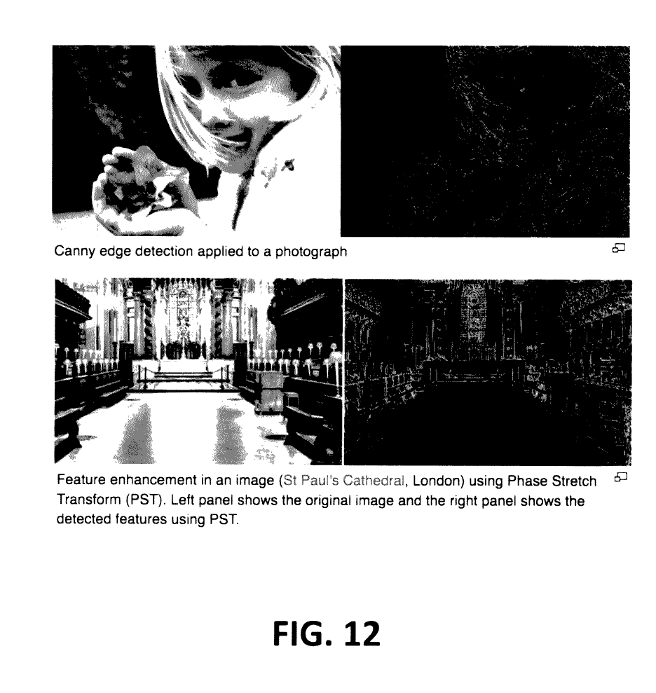

Please see FIG. 12 for examples of edge detection.

### Concise Course of Action Summarized

The specific application of the embodiments of the present invention is to utilize the techniques described, infra, in order to reliably define the difference between images taken at exactly the same geographic location and at exactly the same height.

One of the following five criteria are defined per parking space based on results of the application of the embodiments of the present invention:
(1) The parking space is empty. The image matches the based image obtained during a setup flight.
(2) The parking space has a new vehicle, i.e., the image analysis has detected a difference and the application of the embodiments of the present invention records a new arrival.
(3) The parking space is empty after a vehicle had been detected, i.e., the application of the embodiments of the present invention registers departure or a vacated lot.
(4) The parking space is not empty, but the vehicle permitted stay time is within the time limit defined the officer.
(5) The parking space is not empty and the vehicle permitted stay time is outside the time limit defined the officer so a ticket is issued.

### Impressions

It will be understood that each of the elements described above or, two or more together, may also find a useful application in other types of constructions and methods differing from the types described above.

Although the methods and constructions are illustrated and described above in the form of a series of acts, events, and structures, it will be appreciated that the various methods, processes, or structures of the application of the embodiments of the present invention are not limited by the illustrated ordering of the acts, events, or structures. In this regard, except as specifically provided hereinafter, some acts, events, or structures may occur in different order and/or concurrently with other acts, events, or structures apart from those illustrated and described herein in accordance with the application of the embodiments of the present invention. It is further noted that not all illustrated steps or structures may be required to implement a process, a method, or a structure in accordance with the application of the embodiments of the present invention, and one or more of these acts or structures may be combined. The illustrated methods, other methods, and structures of the application of the embodiments of the present invention may be implemented in hardware, software, or combinations thereof, in order to provide the control functionality described herein, and may be employed in any system including, but not limited to, the above illustrated application of the embodiments of the present invention, wherein the application of the embodiments of the present invention is not limited to the specific applications and embodiments illustrated and described herein.

While the embodiments of the present invention have been illustrated and described as embodied in a parking space control method and system with unmanned paired aerial vehicle (UAV), nevertheless, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A method for parking space control, comprising the steps of:
a) flying a drone at regular intervals along a predefined path that covers an area of a parking lot;
b) scanning and registering the parking lot;
c) using, by software, features detection techniques as a part of image analysis algorithms;
d) scanning and searching data from the parking lot for similarities within a given time period to form an analysis;
e) determining, by the analysis, two outcomes for a specific parking lot including one of a new vehicle is parked and an old vehicle is still located at a same parking lot;
f) registering new vehicles at the time of detection;
g) registering and checking longer parked vehicles' stay time for violation;
h) determining if there is a violation;
i) flagging and marking the vehicle on a smart phone or tablet for an officer to view, locate, and ticket, if the answer to step h is yes;
j) determining if the parking time exceeds that allowed in the area of the parking lot;
k) flagging ticket alerts on program and emailing to a supervisor for evaluation and printing, if answer to step j is yes;
l) determining if a vehicle can be exempt from the rules;
m) deciding, by the supervisor, to generate a ticket with a click of a button, if answer to step 1 is no;
n) creating, by the supervisor, the ticket;
o) walking to the vehicle in order to assign the ticket thereto; and
p) repeating cycle after one of an hour and as approved.

2. The method of claim 1, wherein the vehicle that can be exempt from the rules include personnel cars, other types of parked vehicles, and vehicles of vendors.

3. A method for controlling a parking lot, comprising the steps of:
a) inputting data;
b) image detecting analyzing with feature detection, key point detector, and descriptor extractor algorithm;
c) extracting key points;
d) decision analyzing; and
e) defining results and channeling analysis towards an application in parking areas' surveillance methodologies.

4. The method of claim 3, wherein said inputting step includes inputting three images at a beginning of each step of an analysis at a specific waypoint.

5. The method of claim 3, wherein said inputting step includes inputting two images if a drone is arriving at a waypoint for the first time during a monitoring flight.

6. The method of claim 3, wherein said extracting step includes extracting areas with specific location and magnitude in image data defining features in each image generated during image detecting.

7. The method of claim 3, wherein said analyzing step includes processing and interpreting results for the all three images.

8. The method of claim 3, wherein said analyzing step includes comparing distances between key points for the three images in order to define significant differences between them.

9. The method of claim 3, wherein said analyzing step includes removing noises generated by environment and return key points having only significant features.

10. The method of claim 3, wherein said defining step includes defining results and channeling analysis towards the application in parking areas' surveillance methodologies.

11. The method of claim 3, wherein the results include one of:
a) no differences detected between the three images, and as such, a vehicle is not parked and the parking lot is empty;
b) difference detected between all of the three images, and as such, the parking lot is either vacated or there is an arrival of a new vehicle; and
c) differences detected between an original image, but not between a current image and a previous image, and as such, there is an old vehicle that had been detected last time and still occupies the parking lot, so thereby do one of issue a ticket and note an update on duration of parking since registration.

12. The method of claim 11, wherein the original image is taken during a set-up flight when the parking lot is empty, and as such, is used as the base state, and as such, is considered a normal state of the area with no object of interest.

13. The method of claim 11, wherein the previous image is taken during a previous flight of the drone for the waypoint of interest.

14. The method of claim 11, wherein the current image is taken during a current flight of the drone for the waypoint of interest.

15. A system for controlling a parking lot, comprising:
a) a managing device;
b) an image capture device;
c) a storage device; and
d) a user device;
wherein said user device is linkable together by network communication links.

16. The system of claim 15, wherein said managing device includes a controller; and
wherein said controller is part of, or associated with, said managing device.

17. The system of claim 16, wherein said controller is adapted for controlling an analysis of video data received by an UAV camera.

18. The system of claim 17, wherein said controller includes a processor; and
wherein said processor controls overall operation of said managing device by execution of processing instructions that are stored in a memory connected to said processor.

19. The system of claim 18, wherein said memory represents any type of tangible computer readable medium including at least one of random access memory (RAM), read only memory (ROM), magnetic disk or tape, optical disk, flash memory, and holographic memory.

20. The system of claim 18, wherein said memory includes a combination of random access memory and read only memory.

21. The system of claim 18, wherein said processor includes at least one of a single-core processor, a dual-core processor, a multiple-core processor, a digital processor and cooperating math coprocessor, and a digital controller.

22. The system of claim 15, wherein said managing device is a networked device.

23. The system of claim 22, wherein said networked device of said managing device is at least one of a vehicle capture module and a user device.

24. The system of claim 22, wherein said networked device of said managing device is at least one of a central server, a networked computer, and distributed throughout said network.

25. The system of claim 18, wherein said processor, according to instructions contained in said memory, performs vehicle detection, matching phases, and changes in color, position, size, and angle of position.

26. The system of claim 18, wherein said memory stores a video buffering module; and
wherein said video buffering module of said memory receives a video of a select parking area that is captured by a video capture device.

27. The system of claim 26, wherein said memory stores an image buffering module; and
wherein said image buffering module of said memory receives images provided by said video capture device.

28. The system of claim 18, wherein said memory stores a vehicle matching module; and
wherein said vehicle matching module of said memory matches a vehicle with a vehicle in image data.

29. The system of claim 18, wherein said memory stores a stationary vehicle detection module that; and
wherein said stationary vehicle detection of said memory detects objects and/or vehicles within a field of view of said UAV camera.

30. The system of claim 18, wherein said memory stores a timing module; and
wherein said timing module of said memory initiates a timer for measuring a duration that a detected vehicle remains parked in a space.

31. The system of claim 18, wherein said memory stores a violation detection module; and
wherein said violation detection module of said memory checks if parking time exceeds that allowed in an area, and if so, a ticket alert is sent to a supervisor for evaluation and print.

32. The system of claim 31, wherein said ticket alert is stored in at least one of a single module and as multiple modules embodied in different devices.

33. The system of claim 18, wherein a UAV programming module encompasses any collection of, or set of, software instructions executable by said managing device or another digital system so as to configure said processor or said another digital system to perform a task that is an intent of said software instructions.

34. The system of claim 33, wherein said software instructions are stored in a storage medium including at least one of a RAM, a hard disk, and an optical disk.

35. The system of claim 33, wherein said software instructions encompass firmware that is software stored on a ROM.

36. The system of claim 33, wherein said software instructions are organized in various ways, including software components organized as libraries, Internet-based programs stored on a remote server, source code, interpretive code, object code, and directly executable code.

37. The system of claim 33, wherein said software instructions invoke a system-level code or calls to other software residing on a server or other location to perform certain functions.

38. The system of claim 15, wherein various components of said managing device are connected by a bus.

39. The system of claim 15, wherein said managing device includes at least one communication interface.

40. The system of claim 39, wherein said at least one communication interface includes network interfaces for communicating with external devices.

41. The system of claim 39, wherein said at least one communication interface includes at least one of a modem, a router, a cable, and an Ethernet port.

42. The system of claim 39, wherein said at least one communication interface is adapted to receive video and/or image data as input.

43. The system of claim 15, wherein said managing device includes at least one special purpose or general purpose computing device.

44. The system of claim 43, wherein said at least one special purpose or general purpose computing device is a server computer or digital front end (DFE), or any other computing device capable of executing instructions.

45. The system of claim 15, wherein said managing device is connected to an image source for inputting and/or receiving video data and/or image data in electronic format.

46. The system of claim 45, wherein said image source includes an image capture device.

47. The system of claim 46, wherein said image capture device of said image source includes at least one camera installed on a UAV that captures image and video data from the parking area and/or from a parking area of interest.

48. The system of claim 47, wherein said UAV flies at regular intervals along a predefined path that covers the area.

49. The system of claim 17, wherein said UAV camera includes near infrared (NIR) capabilities at a low-end portion of a near-infrared spectrum (700 nm-1000 nm) for performing at night in parking areas without external sources of illumination.
